(19) United States
(12) Patent Application Publication
(10) Pub. No.: US 2025/0265556 A1
(43) Pub. Date: Aug. 21, 2025

(54) INFORMATION PROCESSING SYSTEM, INFORMATION PROCESSING METHOD, AND INFORMATION STORAGE MEDIUM

(71) Applicant: RAKUTEN GROUP, INC., Tokyo (JP)

(72) Inventors: Asmita Harishankar Gahlot, Bangalore (IN); Boaz Yaniv, Tokyo (JP); Julien Johann Cherubin Cayzac, Tokyo (JP); Louise Mary Caroline Jones, Tokyo (JP); Oleg Levy, Tokyo (JP); Yoav Hilman, Tokyo (JP)

(21) Appl. No.: 19/052,236

(22) Filed: Feb. 12, 2025

(30) Foreign Application Priority Data
Feb. 15, 2024 (JP) 2024-021378

(51) Int. Cl. G06Q 20/10; G06Q 20/04

(52) U.S. Cl. CPC G06Q 20/10; G06Q 20/047

(57) ABSTRACT

An information processing system configured to: present, when a first user is registered with an electronic money service that operates in cooperation with a cooperative service that is provided to the first user and a second user and an instruction to send a remittance amount of electronic money from the first user to the second user is given, a receiving method for the electronic money to the second user; and transmit, when an operation based on the receiving method is input from the second user and the second user is not registered with the electronic money service, information for prompting the second user to register in the electronic money service to the second user. When the second user is registered with the electronic money service based on the information, the remittance amount is added to a balance of electronic money available to the second user.

### CROSS-REFERENCE TO RELATED APPLICATION

The present application claims priority from Japanese application JP 2024-021378 filed on Feb. 15, 2024, the content of which is hereby incorporated by reference into this application.

### BACKGROUND

### 1. Field of the Disclosure

The present invention relates to an information processing system, an information processing method, and an information storage medium.

### 2. Description of the Related Art

There are payment services that allow payments to be made from balances that are electronically managed, such as electronic money. Some of those payment services allow remittance between the balances of a plurality of users.

In Japanese Patent Application Laid-open No. 2019-185767, there is disclosed a method of processing remittance to a remittance target after a user performs an operation for selecting the remittance target through an instant messenger.

Not everyone uses a payment service that manages the balance of electronic money and the like. In order to use such a payment service, a user is required to be registered with the payment service in advance. For that reason, when a certain user remits money to a potential recipient through the payment service, the user is required to confirm whether or not the potential recipient is registered with the payment service.

### SUMMARY

The present disclosure provides a technology for reducing a burden of remitting money to another person through use of an electronically managed balance.

(1) An information processing system, which provides a first user and a second user with a cooperative service that operates in cooperation with an electronic money service that manages electronic money, the information processing system including: a presentation module configured to present to the second user, when the first user is registered with the electronic money service and an instruction to send a remittance amount of electronic money from the first user to the second user is given, a receiving method for the electronic money; and a registration management module configured to transmit to the second user, when an operation based on the receiving method is input from the second user and the second user is not registered with the electronic money service, information for prompting the second user to register with the electronic money service, wherein, when the second user is registered with the electronic money service based on the information, the remittance amount is added to a balance of electronic money available to the second user.

(2) In the information processing system according to Item (1), the cooperative service is a messaging service, and the presentation module is configured to transmit to the second user, when the first user is registered with the electronic money service and the instruction to send the remittance amount of electronic money from the first user to the second user is given, information including the receiving method for the electronic money, as a message from the first user.

(3) In the information processing system according to Item (2), the presentation module is configured to transmit, when the remittance amount is added to the balance of electronic money available to the second user, information for notifying that receipt of the electronic money has been completed by the second user, as a message to the first user through the messaging service.

(4) In the information processing system according to any one of Items (1) to (3), when the second user is registered with the electronic money service, the remittance amount is added to the balance of electronic money available to the second user without presentation of the receiving method for the electronic money.

(5) The information processing system according to any one of Items (1) to (4) further includes a determination module configured to determine, when a plurality of pieces of attribute information required by the electronic money service are stored in association with the second user, that the second user is registered with the electronic money service.

(6) In the information processing system according to Item (5), the registration management module is configured to transmit to the second user, when the operation based on the receiving method is input from the second user and it is determined that the second user is not registered with the electronic money service, information for requesting input of the plurality of pieces of attribute information required by the electronic money service.

(7) In the information processing system according to Item (6), the registration management module is configured to transmit to the second user, when the operation based on the receiving method is input from the second user and it is determined that the second user is not registered with the electronic money service, information for requesting input of a piece of attribute information that is not registered with the cooperative service among the plurality of pieces of attribute information required by the electronic money service.

(8) In the information processing system according to any one of Items (1) to (7), the first user and the second user are each identified by a first account in the cooperative service, the first user and the second user are each identified by a second account different from the first account in the electronic money service, and the first account and the second account regarding the first user are stored in association with each other.

(9) In the information processing system according to Item (8), the registration management module is configured to transmit to the second user, when the operation based on the receiving method is input from the second user and it is determined that the second user is not registered with the electronic money service, one of information for requesting input of attribute information required by the electronic money service or information for requesting designation of another second account with which the attribute information is stored in association, and the registration management module is configured to link, when the other second account is designated by the second user, the first account of the second user and the other second account to each other.

(10) In the information processing system according to Item (9), when the instruction to send the remittance amount of electronic money is given, the second account of the second user and the remittance amount are stored in association with each other, and the registration management module is configured to associate, when the first account of the second user and the other second account are linked to each other, the remittance amount associated with the second account of the second user with the other second account.

(11) The information processing system according to any one of Items (1) to (10) further includes: a privilege granting module configured to grant to the second user, when the first user is registered with the electronic money service and the instruction to send the remittance amount of electronic money from the first user to the second user is given, a privilege having restricted use; and a restriction removal module configured to remove, when the second user is registered with the electronic money service based on the information, the restriction of the privilege granted to the second user.

(12) In the information processing system according to Item (11), the privilege granting module is configured to grant to the second user, when the first user is registered with the electronic money service and the instruction to send the remittance amount of electronic money from the first user to the second user is given, a privilege according to the remittance amount and having restricted use.

(13) There is provided an information processing method including: presenting to the second user, when a first user is registered with an electronic money service that operates in cooperation with a cooperative service that is provided to the first user and a second user and an instruction to send a remittance amount of electronic money from the first user to the second user is given, a receiving method for the electronic money; and transmitting to the second user, when an operation based on the receiving method is input from the second user and the second user is not registered with the electronic money service, information for prompting the second user to register with the electronic money service, wherein, when the second user is registered with the electronic money service based on the information, the remittance amount is added to a balance of electronic money available to the second user.

(14) There is provided a program for causing a computer to function as: a presentation module configured to present to the second user, when a first user is registered with an electronic money service that operates in cooperation with a cooperative service that is provided to the first user and a second user with the cooperative service and an instruction to send a remittance amount of electronic money from the first user to the second user is given, a receiving method for the electronic money; and a registration management module configured to transmit to the second user, when an operation based on the receiving method is input from the second user and the second user is not registered with the electronic money service, information for prompting the second user to register with the electronic money service, wherein, when the second user is registered with the electronic money service based on the information, the remittance amount is added to a balance of electronic money available to the second user.

According to at least one embodiment of the present invention, it is possible to reduce a burden of remitting money to another person through use of an electronically managed balance of electronic money, for example.

### BRIEF DESCRIPTION OF THE DRAWINGS

FIG. 1 is a diagram for illustrating an example of an information processing system according to at least one embodiment of the present invention.

FIG. 2 is a block diagram for illustrating functions implemented by the information processing system.

FIG. 3 is a sequence diagram for illustrating an operation of the information processing system at a time of remittance.

FIG. 4 is a view for illustrating an example of a screen of a messaging service.

FIG. 5 is a view for illustrating an example of a screen for setting a remittance amount.

FIG. 6 is a view for illustrating an example of a message presented to a remittance destination.

FIG. 7 is a table for showing an example of remittance information stored in a receipt plan database.

FIG. 8 is a view for illustrating another example of the message presented to the remittance destination.

FIG. 9 is a sequence diagram for illustrating an operation of the information processing system at a time of receipt.

FIG. 10 is a view for illustrating an example of an account modification screen.

FIG. 11 is a view for illustrating an example of a terms-of-use confirmation screen.

FIG. 12 is a view for illustrating an example of a receipt confirmation screen.

FIG. 13 is a view for illustrating an example of a receipt result screen.

FIG. 14 is a flowchart for illustrating processing of an account management system regarding the remittance.

FIG. 15 is a flowchart for illustrating processing of an electronic money system regarding the remittance.

FIG. 16 is a flowchart for illustrating processing of the account management system regarding the receipt.

FIG. 17 is a flowchart for illustrating processing of the electronic money system regarding the receipt.

### DETAILED DESCRIPTION

Now, at least one embodiment of the present invention is described with reference to the drawings. Redundant description of components denoted by the same reference symbols is omitted.

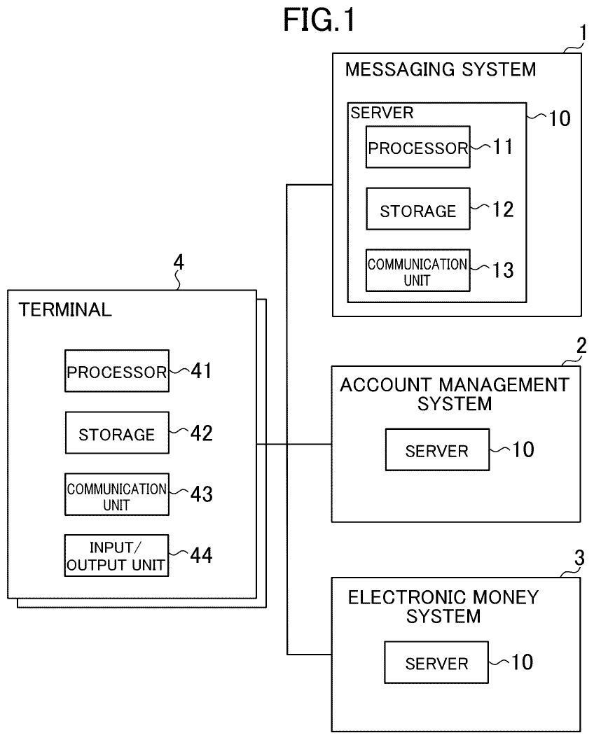

FIG. 1 is a diagram for illustrating an example of an information processing system according to the at least one embodiment of the present invention. The information processing system includes a messaging system 1, an account management system 2, an electronic money system 3, and terminals 4.

The messaging system 1 is a system that cooperates with the terminals 4 to provide a messaging service that enables a plurality of users to exchange messages. The messaging service is an example of a cooperative service that operates in cooperation with an electronic money service. The electronic money system 3 is a system that manages a balance of electronic money of each registered user, and provides a remittance service between a plurality of users. Each of the terminals 4 is, for example, a computer including a user interface, such as a personal computer or a smartphone.

In this case, an account (hereinafter also referred to as “C account”) of a user in the messaging system 1 and an account (hereinafter also referred to as “P account”) of the user in the electronic money system 3 are different from each other. The messaging system 1 internally manages the C account, and the account management system 2 manages information on the P account. The account management system 2 further associates the P account managed thereby with the C account in the messaging system 1. The C account and the P account correspond to a first account and a second account, respectively, in the appended claims.

In the following description, it is assumed that, in the initial state, each of a user of a remittance source and a user of a remittance destination owns a registered C account in the messaging system 1, and the user of the remittance source owns a P account having a balance that can be used for a payment in the electronic money system 3. It is assumed that the user of the remittance destination does not own a P account having a balance that can be used for a payment in the electronic money system 3. Owning a P account having a balance that can be used for a payment is hereinafter also referred to as “a user being registered with the electronic money service” provided by the electronic money system 3. The user of the remittance source and the user of the remittance destination correspond to a first user and a second user, respectively, in the appended claims.

Even when a P account is registered in the account management system 2, the P account may be unusable for a payment from the balance. In the at least one embodiment, when a C account is registered in the messaging system 1, the account management system 2 registers a temporary P account (hereinafter also referred to as “light P account”) associated with the C account. The light P account is identified by identification information of the same type as that of a P account allowed to make a payment, but attribute information stored in association with the identification information on the user is only the attribute information input when the C account was registered in the messaging system 1. In general, use for a payment requires identity of the user to be grasped more precisely, and hence more pieces of attribute information are required. Thus, the attribute information input in a case of using the messaging system 1 is insufficient to configure the P account allowed to make a payment. The P account in which the attribute information required for a payment is registered is hereinafter referred to as “full P account.” In addition, the P account allowed to make a payment is not only a full P account but also requires that the user have confirmed terms of use of the electronic money service. It is assumed herein that a plurality of pieces of attribute information regarding a certain user are pieces of attribute information of mutually different types.

The balance managed by the electronic money system 3 is not required to be a balance of prepaid electronic money. The electronic money system 3 is only required to manage a balance of a value that can be used for an electronic payment. For example, the electronic money system 3 may manage a balance of loyalty points instead of that of the electronic money, or may manage a balance of any currency as the balance of the electronic money. The following description of processing and the like relating to the electronic money can also be applied to other values, such as loyalty points, that can be used for an electronic payment.

Each of the messaging system 1, the account management system 2, and the electronic money system 3 includes one or more servers 10. The server 10 is an example of a computer, and may be another type of computer. Each of the servers 10 includes one or more processors 11, one or more storages 12, and one or more communication units 13. Each of the messaging system 1, the account management system 2, and the electronic money system 3 may be implemented on one or more virtual servers or container platforms.

The terminal 4 includes one or more processors 41, one or more storages 42, a communication unit 43, and an input/output unit 44. In the storage 42 of the terminal 4, for example, an application program for a messaging service downloaded through the Internet is installed.

The processors 11 and 41 operate based on a program (also referred to as “instruction code”) stored in the storages 12 and 42, respectively. The processors 11 and 41 control the communication units 13 and 43, respectively. Each of processors 11 and 41 includes, for example, a central processing unit (CPU), and may further include a graphic processing unit (GPU) and a neural processing unit (NPU). The above-mentioned program may be provided through, for example, the Internet, or may be provided by being stored in a flash memory, a DVD-ROM, or another computer-readable storage medium.

The storages 12 and 42 are each formed of a memory device such as a RAM or a flash memory, and an external storage device such as a hard disk drive (HDD) or a solid state drive (SSD). The storages 12 and 42 each store the above-mentioned program. The storage 12 also stores information and calculation results that are input from the processor 11 and the communication unit 13, and the storage 42 also stores information and calculation results that are input from the processor 41, the communication unit 43, and the input/output unit 44.

The communication units 13 and 43 are each a communication interface, such as a network interface card, which communicates to and from other devices. The communication units 13 and 43 each include, for example, an integrated circuit, an antenna, and a communication terminal for implementing a wireless LAN or a wired LAN. The communication units 13 and 43 may be connected to a communication network. The communication units 13 and 43 operate under the control of the processors 11 and 41, respectively. The communication unit 13 inputs information received from another device to the processor 11 or the storage 12, and transmits information to another device. The communication unit 43 inputs information received from another device to the processor 41 or the storage 42, and transmits information to another device.

The input/output unit 44 includes input devices such as a touch panel, a keyboard, a pointing device, and a microphone, and output devices such as a display panel and a speaker. The input/output unit 44 may include a device (for example, a USB port) for inputting and outputting data to and from an external device including an input device or an output device.

The hardware configurations of the messaging system 1, the account management system 2, the electronic money system 3, and terminal 4 are not limited to the example described above. For example, those systems may each include a device for reading a computer-readable information storage medium (for example, an optical disc drive or a memory card slot) and a device for inputting and outputting data to and from an external device (for example, a USB port). The external device may be an input device or an output device.

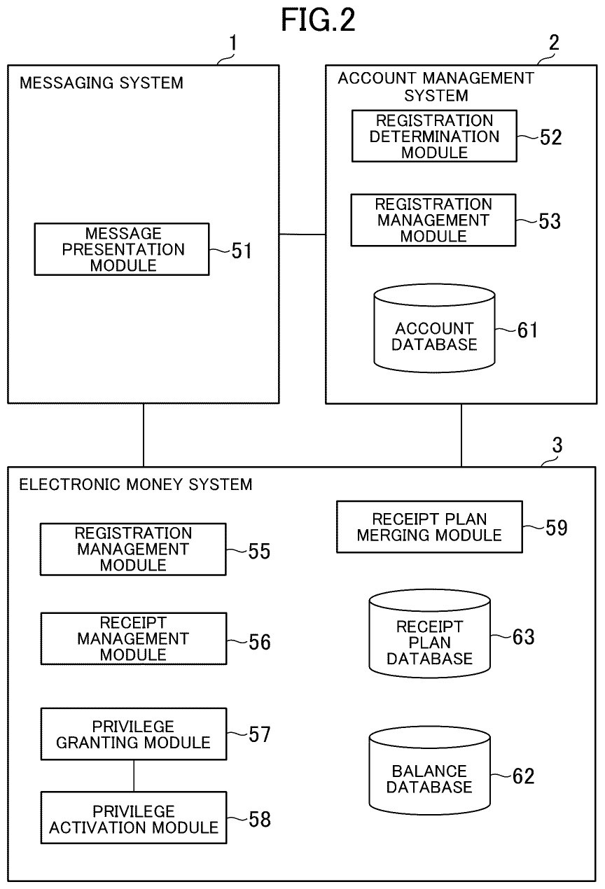

Next, the functions provided by the information processing system are described. FIG. 2 is a block diagram for illustrating functions implemented by the information processing system. The information processing system includes, in terms of functions, a message presentation module 51, a registration determination module 52, a registration management module 53, a remittance management module 55, a receipt management module 56, a privilege granting module 57, a privilege activation module 58, a receipt plan merging module 59, an account database 61, a balance database 62, and a receipt plan database 63. The message presentation module 51 is implemented by the processor 11 of the server 10 forming the messaging system 1 which executes a program that is stored in the storage 12 and that corresponds to the relevant function and controls the communication unit 13 and the like. The registration determination module 52, the registration management module 53, and the account database 61 are implemented by the processor 11 of the server 10 forming the account management system 2 which executes programs that are stored in the storage 12 and that correspond to the relevant functions and controls the communication unit 13 and the like. The remittance management module 55, the receipt management module 56, the privilege granting module 57, the privilege activation module 58, the receipt plan merging module 59, the account database 61, the balance database 62, and the receipt plan database 63 are implemented by the processor 11 of the server 10 forming the electronic money system 3 which executes programs that are stored in the storage 12 and that correspond to the relevant functions and controls the communication unit 13 and the like.

The message presentation module 51 of the messaging system 1 presents a message to a user using the messaging system 1. This message may be transmitted from some system, or may be transmitted by another user. When the user of the remittance source instructs the electronic money system 3 to send a designated amount (remittance amount) of electronic money from the user of the remittance source to the user of the remittance destination, the message presentation module 51 presents information indicating a receiving method for the electronic money (for example, a URL for starting a receiving procedure) to the user of the remittance destination. Through the receiving of the electronic money, the sent electronic money is added to the balance, and a payment from the balance becomes possible. The information indicating the receiving method may be presented not only when an instruction to send electronic money is given, but also when the user of the remittance destination is required to perform a receiving operation.

This presentation is performed by a so-called messaging service. When the message presentation module 51 of the messaging system 1 transmits the information on the receiving method to the terminal 4, the processor 41 executing the application program for the messaging service receives the information through the communication unit 43. Then, the processor 41 outputs the information to the user of the remittance destination through the input/output unit 44. It can be said that the message presentation module 51 presents the information to the user through this transmission, or that the message presentation module 51 controls the terminal 4 to directly present the information to the user.

In addition, when the user of the remittance destination completes the receiving operation based on the information indicating the receiving method and the remittance amount is added to the balance of the user which can be used for a payment, the message presentation module 51 transmits, to the user of the remittance source, information notifying the user of completion of the receipt as a message.

The account database 61 of the account management system 2 stores information on the account of a user to be used by the electronic money system 3, specifically, the information includes the identification information on the account and one or more pieces of attribute information on a user. The account database 61 is mainly formed of the storage 12. The account database 61 may be implemented by the storage 12 and a database management system implemented by the processor 11 executing a database program.

The registration determination module 52 of the account management system 2 determines whether or not a user (for example, the user of the remittance destination) is registered with the electronic money service. More specifically, the registration determination module 52 determines that a user is registered with the electronic money service when predetermined attribute information is stored in the account database 61 in association with the identification information on the user (precisely, the identification information on the account of the user in the messaging system 1 or the electronic money system 3). Specifically, the predetermined attribute information is a plurality of pieces of attribute information required (for a payment) by the electronic money service.

When the user of the remittance destination inputs, to the terminal 4, an operation based on the information on the receiving method and it is determined that the user of the remittance destination is not registered with the electronic money service, the registration management module 53 of the account management system 2 transmits, to the user of the remittance destination, information for prompting the user to register with the electronic money service. The information to be transmitted may be information for prompting the user to register with the electronic money service or information for requesting designation of another P account with which the attribute information required for a payment is stored in association.

In this case, the information for prompting the registration in the electronic money service may be information for requesting input of at least some of the plurality of pieces of attribute information required by the electronic money service. More specifically, the information for prompting the registration in the electronic money service may be information for requesting input of a piece of attribute information (for example, an email address, a password, or a user name) that is not registered in the messaging service among the plurality of pieces of required attribute information. The attribute information (for example, a telephone number) registered in the messaging service may be stored in advance in the account management system 2 from the messaging system 1. The attribute information may be stored at a time at which the user is registered with the messaging service.

Further, when another P account is designated by the user of the remittance destination, the registration management module 53 links the P account with the C account of that user. In this case, the registration management module 53 causes the receipt plan merging module 59 to associate, with the designated P account, information on the remittance amount stored in association with the light P account. The association of the remittance amount is described later in detail.

The balance database 62 of the electronic money system 3 stores the balance of a user using the electronic money system 3, the balance can be used for a payment. The balance database 62 stores, in the storage 12, the identification information on the P account and the balance in association with each other.

When the user of the remittance source gives an instruction for remittance to the user of the remittance destination, the receipt plan database 63 of the electronic money system 3 stores, in the storage 12, the identification information on the (full) P account of the user of the remittance source, the identification information on the (light or full) P account of the user of the remittance destination, the remittance amount, and the reception date of the instruction in association with each other.

The remittance management module 55 of the electronic money system 3 receives the instruction for remittance to the user of the remittance destination (hereinafter also referred to as “receiving user”) from the user of the remittance source. When the P account of the user of the remittance destination requires the receiving operation, the remittance management module 55 stores, in the receipt plan database 63, the remittance amount in association with the user of the remittance destination. When the P account of the user of the remittance destination does not require the receiving operation, the remittance management module 55 adds the remittance amount to the balance of the user of the remittance destination in the balance database 62.

The receiving operation includes at least some of accessing a receiving UI provided by the electronic money system 3, registering missing attribute information required for using the electronic money service by the receiving user, and confirming the terms of use of the electronic money service. Cases in which the receiving operation is required include at least one of a case in which attribute information required by the electronic money service for the user of the remittance destination is not registered or a case in which the user of the remittance destination has not confirmed the terms of use. The cases in which the receiving operation is required may also include a case in which the user of the remittance destination does not wish automatic receiving.

When the receiving user performs the receiving operation and is registered with the electronic money service by the registration management module 53, the receipt management module 56 of the electronic money system 3 adds the remittance amount stored in association with the receiving user in the receipt plan database 63 to the balance available to the receiving user. The balance is stored in the balance database 62.

When the user of the remittance source is registered with the electronic money service and the instruction to send the remittance amount of electronic money from the user of the remittance source to the user of the remittance destination is acquired, the privilege granting module 57 of the electronic money system 3 grants a privilege having restricted use to the user of the remittance destination. The privilege to be granted may be a privilege according to the remittance amount, for example, loyalty points obtained by multiplying the remittance amount by a predetermined coefficient.

When the receiving user is registered with the electronic money service, the privilege activation module 58 of the electronic money system 3 removes the restriction on the privilege granted to the receiving user and enables the privilege to be used.

When the C account of the receiving user is linked to a new P account different from the originally associated P account, the receipt plan merging module 59 of the electronic money system 3 associates, with the new P account, the remittance amount associated with the original P account based on an instruction from the registration management module 53.

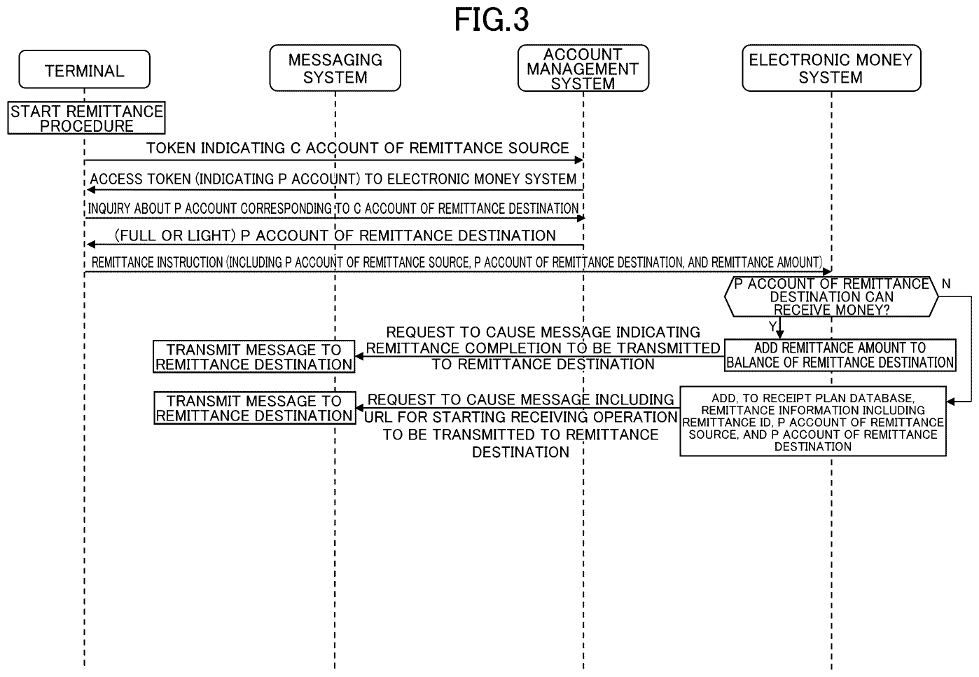

Next, an overview of an operation of the information processing system in remitting and receiving electronic money is described. FIG. 3 is a sequence diagram for illustrating the operation of the information processing system at a time of remitting the electronic money. The terminal 4 illustrated in FIG. 3 is the terminal 4 operated by the user of the remittance source. In this case, the terminal 4 is executing the application program for providing the messaging service. In addition, a user interface and communication for accessing the account management system 2 and the electronic money system 3 are provided by a so-called mini app that runs within the application program. The mini app runs by a kind of program described in HTML format. The messaging system 1 may deliver HTML data or the like corresponding to the program of the mini app to the terminal 4, or the account management system 2 and the electronic money system 3 may deliver HTML data or the like to the terminal 4 as required.

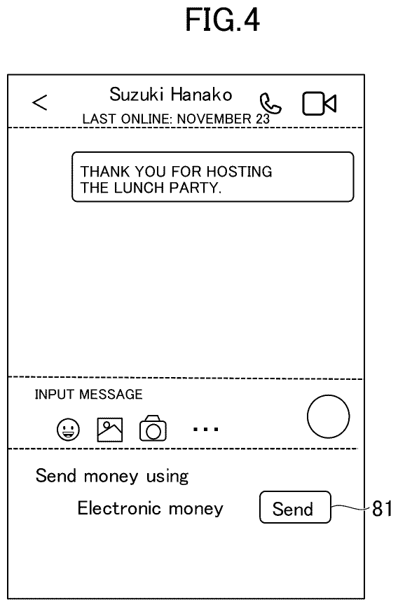

First, the user of the remittance source operates the terminal 4 to designate the account of the remittance destination, and the remittance procedure is thus started. FIG. 4 is a view for illustrating an example of a screen of the messaging service. FIG. 4 and other screens described below are displayed on a screen of terminal 4. FIG. 4 shows a screen for displaying messages that are exchanged with “Suzuki Hanako,” who is a user to be the remittance destination, and on this screen, a button 81 for starting the remittance procedure is displayed. When the user of the remittance source presses the button 81, the remittance procedure is started.

When the remittance procedure is started, the terminal 4 uses the mini app to transmit a token including the C account of the user of the remittance source (hereinafter referred to simply as “C account of the remittance source”) to the account management system 2. The token is a kind of authentication information for authenticating the user of the C account. In response thereto, the registration determination module 52 of the account management system 2 transmits, to the terminal 4, an access token to the electronic money system 3 which includes the P account associated with the C account of the remittance source. In this case, although not shown in FIG. 3, the terminal 4 may use the access token to inquire of the electronic money system 3 about the balance of the user of the remittance source and acquire a value of that balance.

The terminal 4 also uses the mini app to acquire the C account of the remittance destination and inquire of the account management system 2 about the P account corresponding to the C account of the remittance destination. In response thereto, the registration determination module 52 of the account management system 2 returns the P account of the user of the remittance destination to the terminal 4. This P account may be a full P account, or may be a light P account. It is not a problem if the P account can not make a payment from the balance thereof.

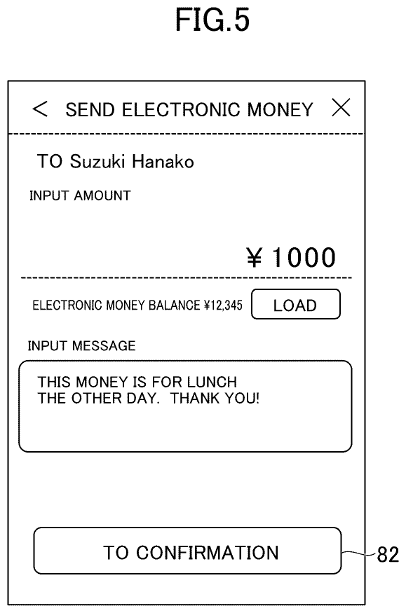

In this case, the terminal 4 uses the mini app to acquire a remittance amount to the user of the remittance destination from the user of the remittance source. FIG. 5 is a view for illustrating an example of a screen for setting the remittance amount, and the balance of the user of the remittance source is also displayed on the screen. In the example of FIG. 5, the terminal 4 acquires the remittance amount to the user of the remittance destination and a message to that user which are input by the user of the remittance source. When the user of the remittance source presses the button 82 and further inputs a final instruction on a confirmation screen (not shown), a remittance instruction is transmitted from the terminal 4 to the electronic money system 3.

The remittance instruction includes the P account of the remittance source, the P account of the remittance destination, and the remittance amount, and is the instruction for remittance to the user of the remittance destination from the user of the remittance source. The remittance management module 55 of the electronic money system 3 receives the remittance instruction. Then, the remittance management module 55 then determines whether or not the P account of the user of the remittance destination can receive the money without the receiving operation. The remittance management module 55 may determine that the relevant P account can receive the money without the receiving operation when the P account of the remittance destination is a full P account and terms of use of the electronic money system 3 have been confirmed. The remittance management module 55 may also determine that the relevant P account can receive the money without the receiving operation when, in addition to the above-mentioned conditions, a condition that information indicating that the user of the remittance destination has set in advance a preference for the receiving without the receiving operation is stored is satisfied.

When it is determined that the relevant P account can receive the money, the remittance management module 55 adds the remittance amount to the balance stored in the balance database 62 in association with the P account of the remittance destination. The remittance management module 55 also requests the messaging system 1 to transmit a message indicating that the remittance has been completed to the user of the remittance destination. This message transmission request may be achieved when the remittance management module 55 requests the terminal 4 to transmit the message and the terminal 4 that has received the request instructs the message presentation module 51 of the messaging system 1 to transmit the message. In response to this request, the message presentation module 51 presents the message to the user of the remittance destination.

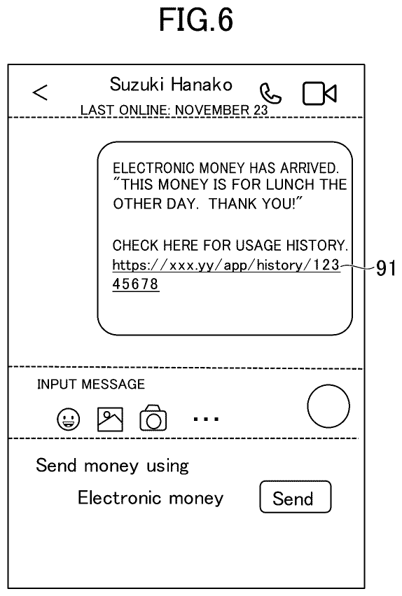

FIG. 6 is a view for illustrating an example of a message presented to the remittance destination, and is a view for illustrating an example of a message presented when it is determined that the relevant P account can receive the money. In the example of FIG. 6, the message being presented includes a sentence indicating that the electronic money has been received, a sentence input by the user of the remittance source, and a link 91 that allows the remittance to be confirmed.

Meanwhile, when it is determined that the relevant P account cannot receive the money, the remittance management module 55 adds, to the receipt plan database 63, remittance information including a remittance ID, the P account of the remittance source, the P account of the remittance destination, and the remittance amount.

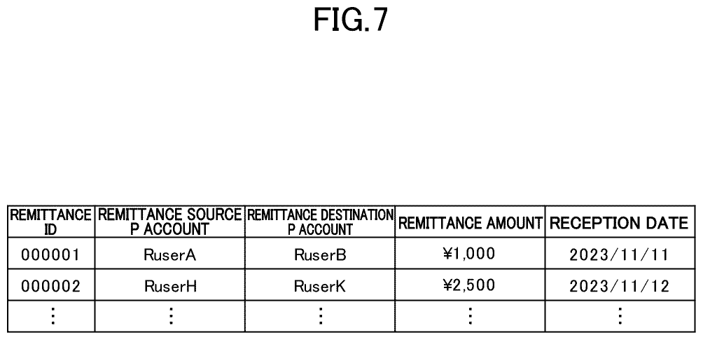

FIG. 7 is a table for showing an example of the remittance information stored in the receipt plan database 63. The receipt plan database 63 stores the remittance information for each of P accounts of a plurality of remittance destinations. In the example of FIG. 7, the remittance information includes the reception date in addition to the remittance ID, the P account of the remittance source, the P account of the remittance destination, and the remittance amount. A set of one or more pieces of remittance information for a P account of a certain remittance destination, which is stored in the receipt plan database 63, is referred to as “receipt plan list.”

Further, when it is determined that the relevant P account cannot receive the money, the remittance management module 55 requests the messaging system 1 to transmit a message including information (URL) for starting the receiving operation to the user of the remittance destination. This request may be achieved when the remittance management module 55 requests the terminal 4 to transmit the message and the terminal 4 that has received the request instructs the message presentation module 51 of the messaging system 1 to transmit the message. In response to this request, the message presentation module 51 causes the terminal 4 to present the message to the user of the remittance destination. The message may be presented by the message presentation module 51 transmitting the message to the terminal 4 of the user of the remittance destination and the terminal 4 displaying the message.

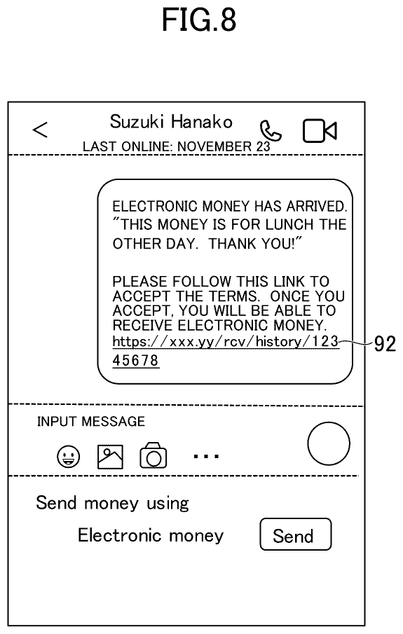

FIG. 8 is a view for illustrating an example of a message presented to the remittance destination, and is a view for illustrating an example of a message presented when it is determined that the relevant P account cannot receive the money. In the example of FIG. 8, the message having been sent includes a sentence indicating that electronic money has been remitted, a sentence input by the user of the remittance source, and a link 92 to a URL for starting an operation for receiving the remitted electronic money.

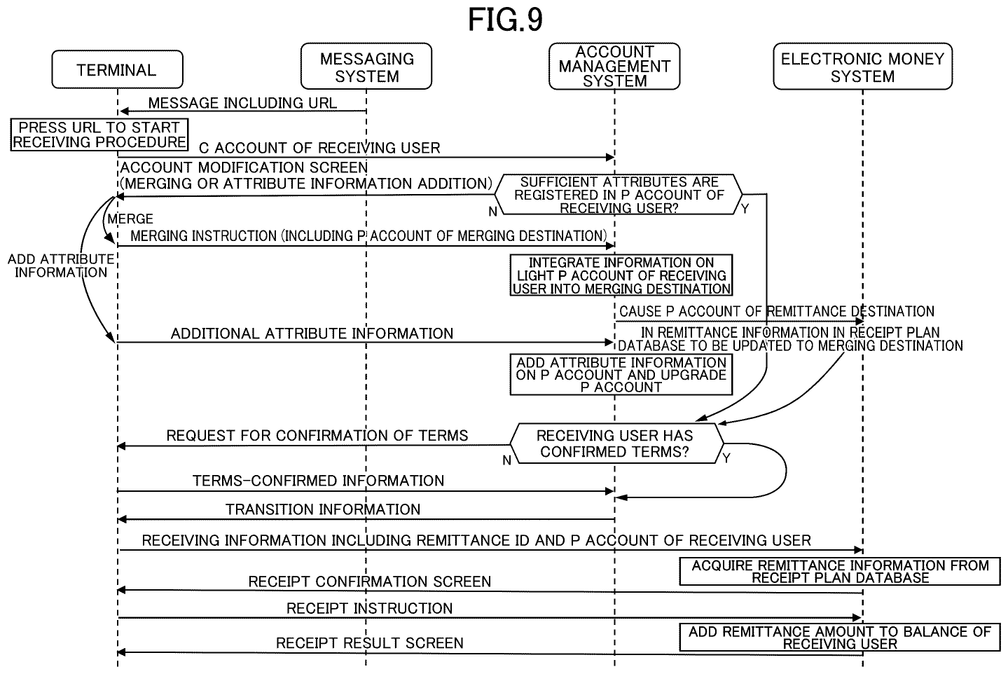

FIG. 9 is a sequence diagram for illustrating an operation of the information processing system at a time of receipt. The flow illustrated in FIG. 9 indicates the operation of the information processing system performed when the message including the URL for starting the receiving operation is transmitted in the flow illustrated in FIG. 3. The terminal 4 illustrated in FIG. 9 is the terminal 4 operated by the user of the remittance destination. In the same manner as the terminal 4 operated by the user of the remittance source, the terminal 4 operated by the user of the remittance destination executes the application program for providing the messaging service, and a so-called mini app runs therein.

First, the message including the URL is transmitted from the messaging system 1 to the terminal 4, and is presented to a user of a transmission destination (receiving user). Then, when the receiving user presses the URL to input the operation for starting the receiving to the terminal 4, the receiving procedure is started.

When the receiving procedure is started, the terminal 4 executing the mini app transmits a token including the C account of the receiving user to the account management system 2. The registration determination module 52 of the account management system 2, first determines whether or not the attribute information required for making a payment by the electronic money service is registered in the P account of the receiving user. This determination may be performed based on whether or not the P account is a full P account.

When sufficient attributes are not registered (N), the account management system 2 transmits information for displaying an account modification screen. In this case, when the P account of the receiving user is a light P account, sufficient attributes are not registered. The account modification screen allows the receiving user to select merging and attribute information addition in order to use the electronic money service under a full P account. In the merging, the registration management module 53 of the account management system 2 acquires another P account of the receiving user input by the receiving user, merges the information on the light P account with the another P account, and sets the another P account to a full P account. In the attribute information addition, the light P account is upgraded to a full P account by acquiring required attribute information from the user and storing the information in the account database 61. The setting the P account of the receiving user to a full P account is one of conditions that allows the receiving user to receive the electronic money sent from the remittance source and add the electronic money to the balance.

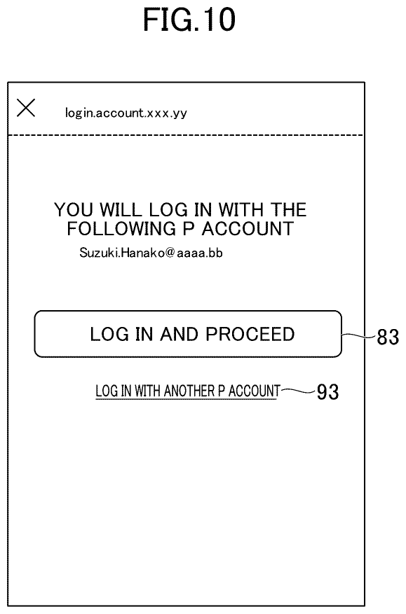

FIG. 10 shows an example of the account modification screen. In FIG. 10, the light P account of the receiving user is displayed, and a link 93 is selected to instruct the merging, and a button 83 is selected to instruct the attribute information addition.

For example, when the link 93 is pressed to select the merging, the terminal 4 acquires a P account of a merging destination input by the receiving user on an input screen (not shown), and transmits a merging instruction including that P account to the account management system 2. In this case, the P account of the merging destination is, for example, a P account registered in the electronic money service and not linked to the C account. Then, the registration management module 53 of the account management system 2 integrates the information on the light P account of the receiving user into the P account of the merging destination. In this integration, the registration management module 53 associates the C account associated with the light P account with the P account of the merging destination, and sets the attribute information set only for the light P account in the P account of the merging destination. Then, the registration management module 53 transmits, to the electronic money system 3, an instruction to update the remittance information associated with the light P account of the receiving user in the receipt plan database 63 so as to be associated with the P account of the merging destination. When a merging operation based on that instruction is completed, the registration management module 53 deletes the light P account.

The registration management module 53 may execute processing for the integration only when the P account of the merging destination is a full P account. Instead, when the attribute information required for a full P account is not registered in the P account of the merging destination after the integration, the registration management module 53 may prompt the user to input the missing attribute information, and store the input attribute information in the account database 61. Processing relating to the inputting of the attribute information may be the same as processing for the attribute information addition. As a result, the integrated P account becomes a permanent full P account.

In FIG. 10, when, for example, the button 83 is pressed to select the attribute information addition, the terminal 4 acquires the additional attribute information input by the receiving user on an input screen (not shown), and transmits that additional attribute information to the account management system 2. The registration management module 53 of the account management system 2 stores the received additional attribute information in the account database 61 in association with the light P account. As a result, the P account is upgraded to a full P account. The registration management module 53 may transmit, to the terminal 4 of the receiving user as information for displaying the input screen, information of a screen for inputting, as the additional attribute information, one or more pieces of attribute information that are not registered in the light P account among the plurality of pieces of attribute information required for a payment from the balance in the electronic money service. The registration management module 53 may acquire the additional attribute information input through the screen. In the light P account, attribute information required for using the messaging service is registered.

After the processing for the merging or the attribute information addition is completed, or after it is determined that attribute information sufficient for a payment is registered in the original P account of the receiving user (Y), the registration management module 53 determines whether or not the receiving user has confirmed the terms regarding the use of the electronic money service. This confirmation of the terms is one of the conditions that allows the receiving user to receive the electronic money sent from the remittance source. When it is determined that the terms have not been confirmed (N), the registration management module 53 transmits information for requesting the confirmation of the terms (for example, information for displaying a terms-of-use confirmation screen) to the terminal 4.

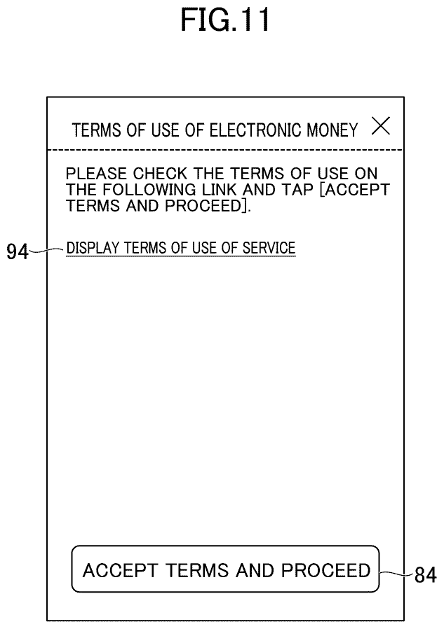

FIG. 11 is a view for illustrating an example of the terms-of-use confirmation screen. When the receiving user performs an operation indicating that the receiving user has confirmed the terms of use, terms-confirmed information is transmitted. This operation may be, for example, pressing a button 84 after pressing a link 94 for displaying the terms of use. The button 84 may change to a pressable state only after the terms of use are displayed.

The registration management module 53 acquires the information indicating that the receiving user has confirmed the terms (terms-confirmed information) from the terminal 4. In this case, when it is determined that the terms have been confirmed (Y), those processing steps are skipped.

When the above-mentioned processing results in the state in which the terms have been confirmed, the account management system 2 transmits transition information and an access token to the terminal 4. The transition information is information for causing the screen being displayed on a browser to transition from the screen of the account management system 2 to the screen of the electronic money system 3. In this case, the access token is information required for the electronic money system 3 to authenticate the P account, and includes information indicating the P account of the receiving user and information indicating that the P account has been authenticated.

The terminal 4 transmits, based on the transition information, receiving information including the P account of the receiving user (precisely, the access token for the P account) and the remittance ID to the electronic money system 3. The receipt management module 56 of the electronic money system 3 receives the receiving information, and acquires the remittance information from the receipt plan database 63 based on the remittance ID included in the request. The receipt management module 56 transmits, to the terminal 4, information for displaying a receipt confirmation screen for asking the receiving user whether or not to execute the receiving of the remitted electronic money based on the remittance information.

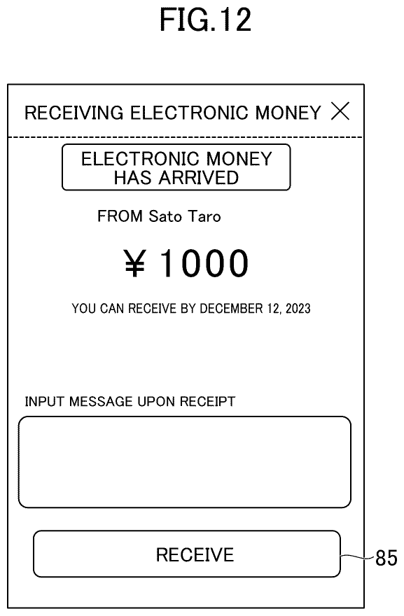

FIG. 12 is a view for illustrating an example of the receipt confirmation screen. On the receipt confirmation screen displayed by the terminal 4, information on the user of the remittance source and the remittance amount are displayed. When the receiving user presses a button 85 to instruct to receive the displayed remitted electronic money, the terminal 4 transmits a receipt instruction to the electronic money system 3. In the example of FIG. 12, the receipt confirmation screen also includes a field for inputting a message to be sent to the user of the remittance source. When the message is input, the terminal 4 may transmit information on the message to the electronic money system 3 together with the receipt instruction.

When the receipt management module 56 receives the receipt instruction, the receipt management module 56 adds the remittance amount included in the remittance information to the balance of the receiving user. Then, the receipt management module 56 transmits information indicating a receipt result, that is, information for displaying a receipt result screen of FIG. 9, to the terminal 4, and the terminal 4 presents the receipt result to the receiving user.

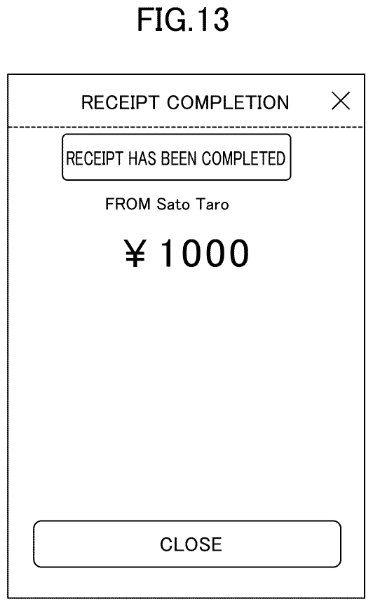

FIG. 13 is a view for illustrating an example of the receipt result screen displayed by the terminal 4. When this screen is displayed, the operation relating to the receiving is ended. However, when a message has been input on the receipt confirmation screen, information for requesting the transmission of the message to the user of the remittance source is transmitted from the receipt management module 56 of the electronic money system 3 to the messaging system 1 or the terminal 4. When the terminal 4 receives the request, the terminal 4 requests the messaging system 1 to transmit the message. The receipt management module 56 may transmit that requesting information together with the information for displaying the receipt result screen.

Although not shown in FIG. 3 and FIG. 9, the electronic money system 3 may grant the restricted privilege to the receiving user after receiving the instruction to remit the electronic money. The electronic money system 3 may also remove the restriction on the privilege after the receiving user is registered with the electronic money service. For example, when the remittance management module 55 adds the remittance information to the receipt plan database 63, the privilege granting module 57 of the electronic money system 3 may calculate an amount of the privilege based on the remittance amount and store the calculated amount of the privilege and information indicating that the privilege is restricted in the storage 12 in association with the P account of the user of the remittance destination (receiving user). The privilege may be, for example, loyalty points that can be used for a payment in electronic commerce or the like. The privilege granting module 57 may calculate, as the amount of the privilege, a value by multiplying the remittance amount by a predetermined coefficient (for example, a value equal to or less than 1).

Further, when the privilege activation module 58 of the electronic money system 3 receives the receipt instruction from the receiving user, the privilege activation module 58 may remove the restriction on the privilege associated with the P account of the receiving user to enable the privilege to be used. The privilege activation module 58 may remove the restriction by updating or deleting the information indicating that the privilege is restricted.

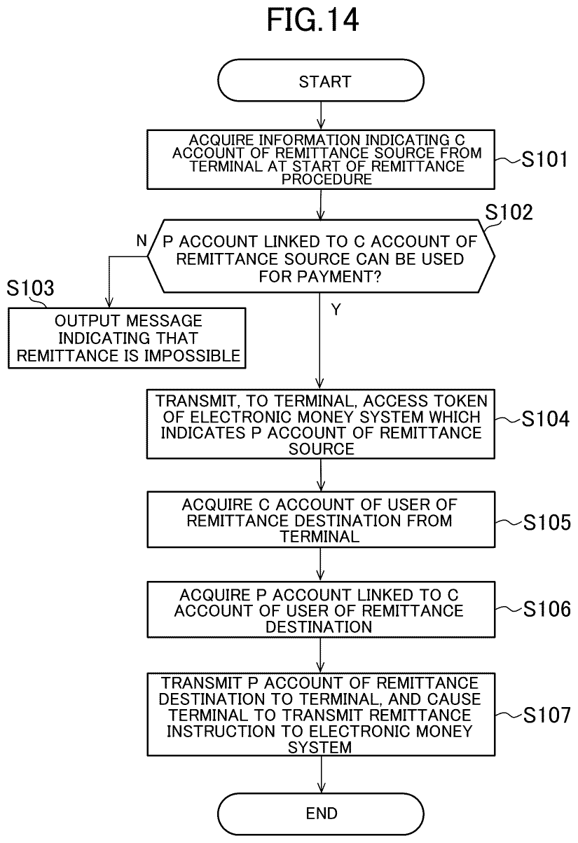

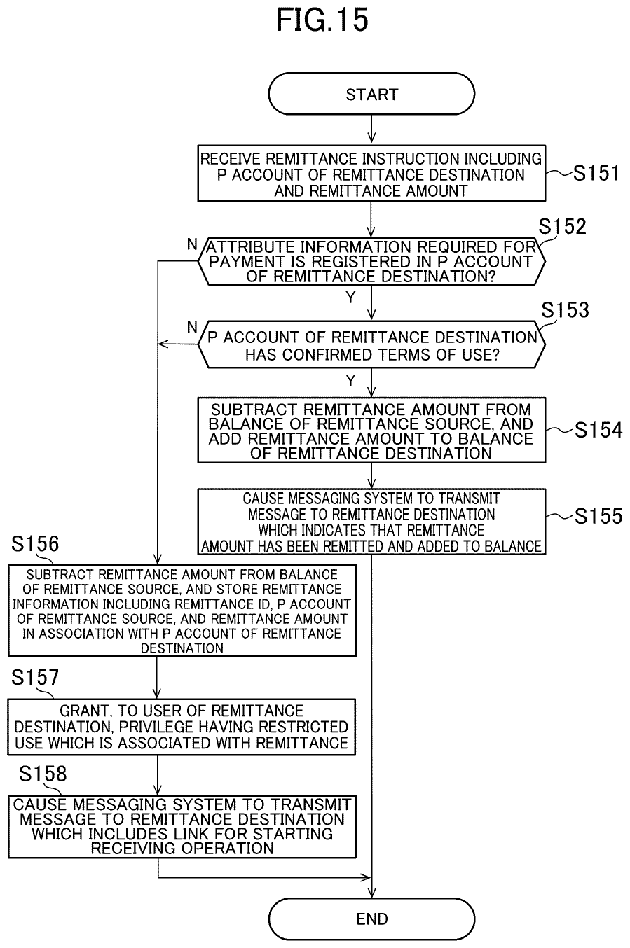

Now, processing of the information processing system regarding the remittance of electronic money is described with reference to flowcharts. FIG. 14 and FIG. 15 are flowcharts for illustrating the processing performed when the user of the remittance source performs the remittance procedure. FIG. 14 is a flowchart for illustrating processing of the account management system 2 regarding the remittance. FIG. 15 is a flowchart for illustrating processing of the electronic money system 3 regarding the remittance.

First, when the user of the remittance source inputs an instruction to start the remittance procedure to the terminal 4, the remittance procedure is started, and the terminal 4 transmits information indicating a C account of the remittance source to the account management system 2. Then, the registration determination module 52 acquires the transmitted information indicating the C account of the remittance source (Step S101). The registration determination module 52 acquires, based on a query including the C account, a P account linked to the C account from the account database 61. In this step, as described above, the types of P accounts include a full P account in which the attribute information required for a payment is registered and a light P account in which a part of the attribute information required for a payment is not registered. In this step, when the P account linked to the C account of the remittance source cannot be used for a payment (for example, the P account is a light P account) (N in Step S102), a message indicating that the remittance is not possible due to absence of a proper P account is output to the terminal 4 (Step S103), and the processing regarding the remittance is ended.

Meanwhile, when the P account linked to the C account of the remittance source can be used for a payment (Y in Step S102), the registration determination module 52 generates an access token to the electronic money system 3 which indicates the P account of the remittance source, and transmits the access token to the terminal 4 (Step S104). The registration determination module 52 further acquires a C account of the user of the remittance destination from the terminal 4 (Step S105). The registration determination module 52 acquires, based on a query including the C account of the remittance destination, the P account linked to the C account from the account database 61 (Step S106). The registration determination module 52 transmits the P account of the remittance destination to the terminal 4 (Step S107).

When the application program of the terminal 4 acquires the P account of the remittance destination, the application program transmits the remittance instruction including information indicating the P account of the remittance source, the P account of the remittance destination, and the remittance amount to the electronic money system 3. Step S107 is also a kind of request to cause the terminal 4 to transmit the remittance instruction. In Step S107, the registration determination module 52 may also transmit at least part of information indicating whether the P account of the remittance destination is a full P account or a light P account and information indicating whether or not the user of the remittance destination has confirmed the terms of use of the electronic money service, and the transmitted information may be included in the remittance instruction.

The processing of the account management system 2 in the remittance procedure is not limited to that described above. The acquisition of the C accounts of the remittance source and the remittance destination (Step S101 and Step S105) may be performed at a time. In this case, the registration determination module 52 may transmit the access token (see Step S104) and the P account of the remittance destination (see Step S107) to the terminal 4 all at once.

Further, it is premised in the example of FIG. 14 that there is always a P account linked to the C account. For example in Step S106, when there is no linked P account, the registration determination module 52 may generate a P account of the remittance destination linked to the C account.

Now, the processing illustrated in FIG. 15 is described. When the remittance instruction is transmitted from the terminal 4, the remittance management module 55 of the electronic money system 3 receives the remittance instruction including the P account of the remittance destination and the remittance amount (Step S151). The remittance management module 55 determines whether or not the attribute information required for a payment from the balance is registered in the P account of the remittance destination (Step S152). In this step, the remittance management module 55 may perform this determination based on the information indicating whether or not the remittance destination is a full P account or a light P account, which is included in the remittance instruction, or may perform this determination based on a result of inquiring of the account management system 2 about whether the P account of the remittance destination is a full P account or a light P account.

When the required attribute information is registered in the P account of the remittance destination (Y in Step S152), the remittance management module 55 determines whether or not (the user indicated by) the P account of the remittance destination has confirmed the terms of use of the electronic money service (Step S153). In this step, the remittance management module 55 may perform this determination based on the information indicating whether or not the terms of use have been confirmed, which is included in the remittance instruction, or may perform this determination based on a result of inquiring of the account management system 2 about whether or not the terms of use of the electronic money service have been confirmed under the P account of the remittance destination.

When the P account of the remittance destination has confirmed the terms of use of the electronic money service (Y in Step S153), the remittance management module 55 subtracts the remittance amount from the balance of the P account of the remittance source, and adds the remittance amount to the balance of the P account of the remittance destination (Step S154). In this case, the user of the remittance destination is not required to perform the receiving operation, and hence it is possible to automatically add the remittance amount to the balance that can be used for a payment. The remittance management module 55 also causes the messaging system 1 to transmit a message to the remittance destination which indicates that the remittance amount has been remitted and added to the balance (Step S155). In this processing, the remittance management module 55 may request the terminal 4 to transmit the message by transmitting information indicating that the remittance amount has been remitted and added to the balance to the terminal 4, or may directly instruct the messaging system 1 to transmit the message.

In this processing, when the required attribute information is not registered in the P account of the remittance destination (N in Step S152) or when the P account of the remittance destination has not confirmed the terms of use (N in Step S153), Step S156 and the subsequent processing steps for prompting the user of the remittance destination to perform the operation for receiving the remitted electronic money are executed.

In Step S156, the remittance management module 55 subtracts the remittance amount from the balance of the P account of the remittance source, and stores the remittance information in the receipt plan database 63 in association with the P account of the remittance destination (Step S156). In this step, the remittance information includes the remittance ID for identifying the remittance information, the P account of the remittance source, the remittance amount, and a reception date of the remittance (current date). In addition, the privilege granting module 57 determines the amount of a privilege based on the remittance amount, and grants the privilege to the user of the remittance destination (Step S157). The use of this privilege is restricted until the remitted electronic money is received. In granting the privilege, the privilege granting module 57 also stores the amount of the privilege in the storage 12 in association with the remittance information. This privilege provides the user of the remittance destination with an incentive for registration in the electronic money service.

After that, the remittance management module 55 causes the messaging system 1 to transmit a message to the remittance destination which includes the link 92 for starting the receiving operation for the remitted electronic money (Step S158). In this processing, the remittance management module 55 may request the terminal 4 to transmit the message by transmitting information including the link 92 for starting the receiving operation to the terminal 4, or may directly instruct the messaging system 1 to transmit the message. The message may include at least one of text indicating that the receiving operation is required or text input by the user of the remittance source.

Step S152 and Step S153 are processing steps for determining whether or not the user of the remittance destination can make a payment from the balance, and are also processing steps for determining whether or not the receiving operation for the remitted electronic money is required. When, in addition to the above-mentioned conditions, a condition that the user of the remittance destination has set in advance a preference for the receiving without the receiving operation and a flag indicating this preference is stored in association with the P account is satisfied, the remittance management module 55 may determine that the relevant P account can receive the money without the receiving operation and execute Step S154 and the subsequent processing steps. Meanwhile, when any one of the above-mentioned conditions or the condition that the flag indicating the preference is stored in association with the P account is not satisfied, the remittance management module 55 may execute Step S156 and the subsequent processing steps.

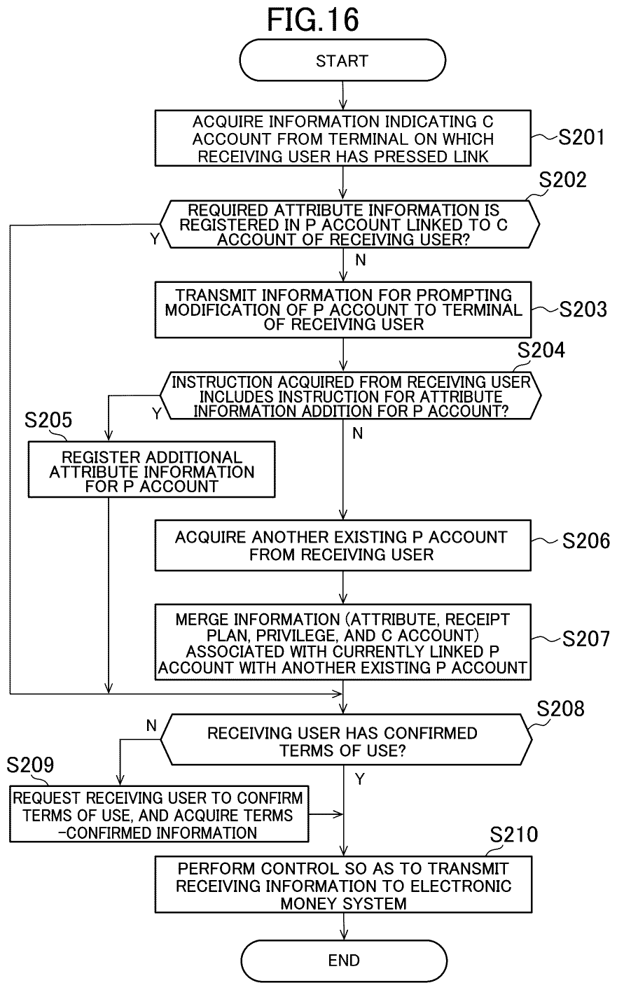

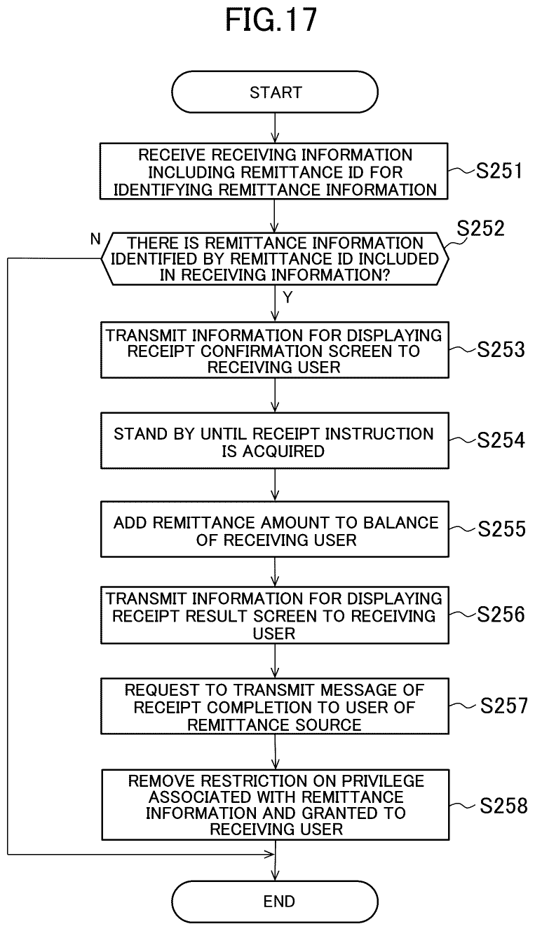

Now, processing of the information processing system regarding the receiving of electronic money is described with reference to flowcharts. FIG. 16 and FIG. 17 are flowcharts for illustrating the processing performed when the receiving user receives the remitted electronic money. FIG. 16 is a flowchart for illustrating processing of the account management system 2 regarding the receipt. FIG. 17 is a flowchart for illustrating processing of the electronic money system 3 regarding the receipt. In FIG. 16 and FIG. 17, the processing performed when the message indicated in Step S158 is transmitted and the user of the transmission destination, that is, the receiving user, performs the receiving operation is illustrated.

First, when the receiving user presses the link 92 in the message on the terminal 4, the terminal 4 transmits information indicating a C account of the receiving user to the account management system 2. Then, the registration management module 53 acquires the information indicating the C account of the receiving user from the terminal 4 (Step S201). The information indicating the C account may be identification information on the C account, or may be a token issued in advance to the terminal 4 by the account management system 2.

The registration management module 53 acquires a P account linked to the C account of the receiving user from the account database 61. The registration management module 53 determines whether or not the attribute information required for a payment of electronic money is registered in the acquired P account (whether or not the P account is a full P account) (Step S202).

When the required attribute information is not registered (N in Step S202), the registration management module 53 transmits information for prompting modification of the P account (information for displaying an account modification screen) to the terminal 4 of the receiving user (Step S203). The information for prompting the modification of the P account may include information for prompting selection of whether to input the additional attribute information or to merge the P account with another existing P account.

The registration management module 53 acquires an instruction regarding account modification, which has been input by the receiving user, from the terminal 4. The registration management module 53 determines whether or not the instruction acquired from the receiving user includes an instruction for the attribute information addition (Step S204). When the instruction for the attribute information addition is included (Y in Step S204), the registration management module 53 may transmit, to the terminal 4, information for displaying an input screen including additional attribute information items. In this step, the registration management module 53 may acquire, from the account database 61, one or more attribute information items that are not registered in the light P account of the receiving user among the plurality of pieces of attribute information required for a payment from the balance in the electronic money service, and transmit information for displaying an input screen including the acquired items as the additional attribute information items. The additional attribute information items may be set in advance, and the registration management module 53 may transmit information for displaying an input screen including the items set in advance, or a program in which those items are set may be delivered to the terminal 4 in advance. In another case, the receiving user may perform input corresponding to the screen for prompting the modification of the P account and the input screen collectively. In this case, the information for prompting the modification of the P account may include the additional attribute information items. In this case, the instruction acquired in Step S204 may include the additional attribute information.

When the receiving user inputs the additional attribute information to the terminal 4, the registration management module 53 acquires the additional attribute information from the terminal 4, and registers the attribute information in the P account of the receiving user (Step S205). Then, Step S208 and the subsequent processing steps are executed.

When the instruction acquired from the receiving user does not include the instruction for the attribute information addition in Step S204, in other words, when the instruction includes the merging instruction (N in Step S204), the registration management module 53 acquires another existing P account (hereinafter called “existing P account”) to be merged from the terminal 4 of the receiving user (Step S206). Then, the registration management module 53 merges, with the existing P account, information associated with the light P account linked to the C account (Step S207).

In this merging, the registration management module 53 executes four processing parts. In a first processing part, the registration management module 53 merges the attribute information stored in the account database 61 in association with the linked light P account with the existing P account. In a second processing part, the registration management module 53 causes the receipt plan merging module 59 of the electronic money system 3 to associate the remittance information stored in the receipt plan database 63 in association with the light P account with the existing P account. In the second processing part, the registration management module 53 also causes the receipt plan merging module 59 to associate the privilege stored in association with the light P account with the existing P account. In a third processing part, the registration management module 53 links the C account of the receiving user to the existing P account. When the linked C account is stored as the attribute information on the P account, the third processing part and the first processing part may be performed together. In a fourth processing part, the registration management module 53 deletes the light P account that was previously linked to the C account. The second processing part is actually performed by the electronic money system 3, and hence it can be said that the registration management module 53 and the receipt plan merging module 59 cooperate to carry out the processing step of Step S207.

When it is determined in Step S202 that the required attribute information is registered (Y in Step S202), or after the processing step of Step S205 or Step S207 has been executed, the registration management module 53 determines whether or not the receiving user has confirmed the terms of use (Step S208). In this step, the registration management module 53 may execute this determination based on the information indicating whether or not the terms of use have been confirmed, which is stored in association with the P account of the receiving user.

When the terms of use have not been confirmed (N in Step S208), the registration management module 53 transmits the information for requesting the confirmation of the terms of use to the terminal 4 of the receiving user, and acquires the terms-confirmed information (Step S209). In requesting the confirmation, the registration management module 53 transmits the information including the terms of use to the terminal 4, and the terminal 4 displays a screen for confirming the terms of use. The terms-confirmed information is also transmitted from the terminal 4 when the receiving user inputs the fact that the receiving user has confirmed the terms. When the terms of use have been confirmed (Y in Step S208), Step S209 is skipped.

Then, the registration management module 53 performs control so as to transmit the receiving information to the electronic money system 3 (Step S210). In Step S210, the registration management module 53 may transmit, to the terminal 4, information (for example, transition information) for causing the terminal 4 to transmit the receiving information including the P account of the receiving user and the remittance ID for identifying the remittance information. The registration management module 53 may also acquire the remittance ID from the terminal 4 in Step S201 and transmit the receiving information directly to the electronic money system 3. In this case, the registration management module 53 may relay a response from the electronic money system 3 to the terminal 4.

Referring to FIG. 17, the processing of the electronic money system 3 is described. The receipt management module 56 of the electronic money system 3 receives the receiving information (Step S251). The receipt management module 56 determines whether or not there is remittance information which is identified by the remittance ID and the P account included in the receiving information from the receipt plan database 63 and which corresponds to an unreceived remittance (Step S252). When there is no such remittance information (N in Step S252), the receipt management module 56 outputs an error message (not shown) to the terminal 4, and the processing of FIG. 17 is ended.

When the remittance information is present (Y in Step S252), the receipt management module 56 transmits the information for displaying the receipt confirmation screen to the receiving user (Step S253). The information for displaying the receipt confirmation screen may include information indicating the user of the remittance source, the remittance amount, and information indicating a receipt deadline. The receipt deadline may be calculated based on the reception date and a receipt period, or may be stored in advance in the receipt plan database 63.

Then, the receipt management module 56 stands by until the receipt instruction is acquired from the terminal 4 (Step S254). After receiving the receipt instruction, the receipt management module 56 adds the remittance amount included in the remittance information to the balance of the receiving user, and stores the balance in the balance database 62 in association with the P account of the receiving user (Step S255). Then, the receipt management module 56 transmits the information for displaying the receipt result screen to the terminal 4 of the receiving user (Step S256). In addition, the receipt management module 56 transmits information for requesting the terminal 4 to transmit a message of receipt completion to the user of the remittance source through the messaging system 1 (Step S257). This requesting information may be transmitted directly to the messaging system 1.

The privilege activation module 58 of the electronic money system 3 also removes the restriction on the privilege which is associated with the remittance information and which have been granted to the receiving user (Step S258). The receiving user can use the privilege only after receiving the remitted electronic money. With this being used as an incentive, it is possible to ensure the receiving of the remitted electronic money by the receiving user.

Embodiments of the present invention are not limited to the at least one embodiment described above. In the at least one embodiment described so far, when the C account is registered in the messaging system 1, the light P account linked thereto is registered in the account management system 2, but such registration is not required to be performed. When the P account linked to the user of the remittance destination cannot be obtained, the remittance management module 55 may store the remittance information in the receipt plan database 63 in association with the C account. The privilege may also be stored in association with the C account. In addition, in place of the processing step of Step S202 of FIG. 16, processing for determining whether or not there is a P account linked to the C account of the receiving user may be performed, and in Step S205 and Step S207, the attribute information, receipt plan, and privilege stored in association with the C account may be used in place of the attribute information, receipt plan, and privilege of the light P account.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing system, which provides a first user and a second user with a cooperative service that operates in cooperation with an electronic money service that manages electronic money, the information processing system comprising:
at least one processor; and at least one memory device that stores a plurality of instructions which, when executed by the at least one processor, causes the at least one processor to:
present to the second user, when the first user is registered with the electronic money service and an instruction to send a remittance amount of electronic money from the first user to the second user is given, a receiving method for the electronic money; and
transmit to the second user, when an operation based on the receiving method is input from the second user and the second user is not registered with the electronic money service, information for prompting the second user to register with the electronic money service,
wherein, when the second user is registered with the electronic money service based on the information, the remittance amount is added to a balance of electronic money available to the second user.

2. The information processing system according to claim 1,
wherein the cooperative service is a messaging service, and
wherein the plurality of instructions cause the at least one processor to transmit to the second user, when the first user is registered with the electronic money service and the instruction to send the remittance amount of electronic money from the first user to the second user is given, information including the receiving method for the electronic money, as a message from the first user.

3. The information processing system according to claim 2, wherein the plurality of instructions cause the at least one processor to transmit, when the remittance amount is added to the balance of electronic money available to the second user, information for notifying that receipt of the electronic money has been completed by the second user, as a message to the first user through the messaging service.

4. The information processing system according to claim 1, wherein when the second user is registered with the electronic money service, the remittance amount is added to the balance of electronic money available to the second user without presentation of the receiving method for the electronic money.

5. The information processing system according to claim 1, wherein the plurality of instructions cause the at least one processor to determine, when a plurality of pieces of attribute information required by the electronic money service are stored in association with the second user, that the second user is registered with the electronic money service.

6. The information processing system according to claim 5, wherein the plurality of instructions cause the at least one processor to transmit to the second user, when the operation based on the receiving method is input from the second user and it is determined that the second user is not registered with the electronic money service, information for requesting input of at least some of the plurality of pieces of attribute information required by the electronic money service.

7. The information processing system according to claim 6, wherein the plurality of instructions cause the at least one processor to transmit to the second user, when the operation based on the receiving method is input from the second user and it is determined that the second user is not registered with the electronic money service, information for requesting input of a piece of attribute information that is not registered with the cooperative service among the plurality of pieces of attribute information required by the electronic money service.

8. The information processing system according to claim 1,
wherein the first user and the second user are each identified by a first account in the cooperative service,
wherein the first user and the second user are each identified by a second account different from the first account in the electronic money service, and
wherein the first account and the second account regarding the first user are stored in association with each other.

9. The information processing system according to claim 8,
wherein the plurality of instructions cause the at least one processor to transmit to the second user, when the operation based on the receiving method is input from the second user and it is determined that the second user is not registered with the electronic money service, one of information for requesting input of attribute information required by the electronic money service or information for requesting designation of another second account with which the attribute information is stored in association, and
wherein the plurality of instructions cause the at least one processor to link, when the other second account is designated by the second user, the first account of the second user and the other second account to each other.

10. The information processing system according to claim 9,
wherein, when the instruction to send the remittance amount of electronic money is given, the second account of the second user and the remittance amount are stored in association with each other, and
wherein the plurality of instructions cause the at least one processor to associate, when the first account of the second user and the other second account are linked to each other, the remittance amount associated with the second account of the second user with the other second account.

11. The information processing system according to claim 1, further comprising:
wherein the plurality of instructions cause the at least one processor to grant to the second user, when the first user is registered with the electronic money service and the instruction to send the remittance amount of electronic money from the first user to the second user is given, a privilege having restricted use; and
wherein the plurality of instructions cause the at least one processor to remove, when the second user is registered with the electronic money service based on the information, the restriction of the privilege granted to the second user.

12. The information processing system according to claim 11, wherein the plurality of instructions cause the at least one processor to grant to the second user, when the first user is registered with the electronic money service and the instruction to send the remittance amount of electronic money from the first user to the second user is given, a privilege according to the remittance amount and having restricted use.

13. An information processing method, comprising:
presenting to the second user, when a first user is registered with an electronic money service that operates in cooperation with a cooperative service that is provided to the first user and a second user and an instruction to send a remittance amount of electronic money from the first user to the second user is given, a receiving method for the electronic money with at least one processor operating with a memory device in a system; and
transmitting to the second user, when an operation based on the receiving method is input from the second user and the second user is not registered with the electronic money service, information for prompting the second user to register with the electronic money service with the at least one processor operating with the memory device in the system,
wherein, when the second user is registered with the electronic money service based on the information, the remittance amount is added to a balance of electronic money available to the second user.

14. A non-transitory information storage medium storing a plurality of instructions, wherein when executed by at least one processor, the plurality of instructions cause the at least one processor to:
present to the second user, when a first user is registered with an electronic money service that operates in cooperation with a cooperative service that is provided to the first user and a second user and an instruction to send a remittance amount of electronic money from the first user to the second user is given, a receiving method for the electronic money; and
transmit to the second user, when an operation based on the receiving method is input from the second user and the second user is not registered with the electronic money service, information for prompting the second user to register with the electronic money service,
wherein, when the second user is registered with the electronic money service based on the information, the remittance amount is added to a balance of electronic money available to the second user.
